(19) United States
(12) Patent Application Publication
(10) Pub. No.: US 2014/0013534 A1
(43) Pub. Date: Jan. 16, 2014

(54) SEALING BUSH FOR A WINDSHIELD WIPING DEVICE

(71) Applicant: GM GLOBAL TECHNOLOGY OPERATIONS LLC, Detroit, MI (US)

(72) Inventors: Joachim LACROIX, Flonheim (DE); Joerg SCHNEIDER, Ruesselsheim (DE)

(21) Appl. No.: 13/938,979

(22) Filed: Jul. 10, 2013

(30) Foreign Application Priority Data
Jul. 11, 2012 (DE) 10 2012 013 728.1

(51) Int. Cl. B60S 1/34; F16J 15/02

(52) U.S. Cl. CPC B60S 1/3495; F16J 15/022
USPC 15/250.3; 277/648

(57) ABSTRACT

A sealing bush of elastic material is provided for a windshield wiping device of a vehicle, for sealing a wiper drive shaft that is guided through an opening in a vehicle wall. This has a cylindrical wall sealing section with an internal diameter, which is greater with respect to the wiper drive shaft, on which two circumferential sealing lips, extending radially with respect to a center axis, are formed surrounding the vehicle wall on both sides. The wall sealing section has a smaller external diameter with respect to the opening edge for forming a radial gap, and a thin-walled shaft sealing section adjoins the wall sealing section on an outer side of the vehicle, which shaft sealing section tapers conically towards the outer side of the vehicle and towards the wiper drive shaft and terminates in an annular seal region for the wiper drive shaft.

### CROSS-REFERENCE TO RELATED APPLICATION

This application claims priority to German Patent Application No. 10 2012 013 728.1, filed Jul. 11, 2012, which is incorporated herein by reference in its entirety.

### TECHNICAL FIELD

The technical field relates to a sealing bush of elastic material for a windshield wiping device of a vehicle, for sealing a wiper drive shaft that is guided through an opening in a vehicle wall.

### BACKGROUND

A sealing bush is known from DE 10 2008 041 663 A1. By means of such sealing bushes, the wiper drive shaft belonging to a windshield wiping device is sealed with respect to the vehicle wall. The vehicle wall can be part of the body or especially in the case of a windshield wiping device in the rear region, also of a vehicle windshield.

A problem in such seals is that the wiper drive shaft can have certain positional and angular tolerances on mounting, where such sealing bushes, in particular after lengthy operation, tend to become jammed, with the result that the sealing bush co-rotates and produces squeaking noises. In extreme cases, leaks can occur with the result that water arrives into the interior of the vehicle and, in addition to corrosion, can also cause electrical malfunctions.

It is therefore at least one object to prevent the above disadvantages and to provide a sealing bush that also seals reliably with respect to the vehicle wall in the case of positional and angular tolerances of the wiper drive shaft. In addition, other objects, desirable features, and characteristics will become apparent from the subsequent summary and detailed description, and the appended claims, taken in conjunction with the accompanying drawings and this background.

### SUMMARY

Further features, possibilities for application and advantages of the invention will emerge from the following description, and from the explanation of example embodiments of the invention which are illustrated in the figures.

In particular, a sealing bush comprises a cylindrical wall sealing section, on which two circumferential sealing lips are formed, extending radially with respect to a center axis, for surrounding the vehicle wall on both sides, and a thin-walled shaft sealing section adjoins the wall sealing section, which shaft sealing section tapers conically towards the center axis and continues into an annular sealing region for sealing with respect to the wiper drive shaft.

At least one advantages is in that through the smaller external diameter of the wall sealing section with respect to the preferably round opening edge, a radial play is present, permitting positional tolerances in the dimension of the radial peripheral gap between the wall sealing section and the opening edge, and hence a reliable seal is ensured between the sealing bush and the vehicle wall. Through the conical tapering of the shaft sealing section in connection with its thin-walled characteristic and its elasticity, angular tolerances in the region of approximately 10° and more can be compensated without a displacement of the sealing bush, where no risk of a jamming of the sealing bush exists. The sealing bush preferably has a wall thickness of approximately 2 mm in the region of the wall sealing section and goes down to approximately 1.5 mm in the region of the shaft sealing section. The sealing bush preferably consists of plastic or rubber.

According to an embodiment, the shaft sealing section enlarges starting from the wall sealing section initially in radial direction in a bell-like manner to form an annular bead and subsequently tapers conically. In so doing, the wall thickness remains unchanged in this region. Through this construction, an obstacle is formed on the outer side of the sealing bush for water running downwards, where a flowing of the water towards the sealing site with respect to the wiper drive shaft is prevented. At the same time, the bell-like shape reduces the rigidity of the sealing bush in the region of the shaft sealing section and enlarges the range of the angle tolerance compensation.

According to an embodiment, the external diameter of the wall sealing section is between approximately 4 and approximately 10 mm smaller than the diameter of the opening, where the positional tolerances typically occurring on mounting are compensated.

According to an embodiment, the sealing bush has a EPDM. This material has a high weather- and moisture-resistance, ozone resistance and a high thermal resistance. In addition, it has a high elasticity and good chemical resistance.

According to an embodiment, the sealing lip, situated on the outer side of the vehicle, has on the outer edge a seal region that is curved towards the opposite sealing lip. Thereby, an annular seal region is defined, which ensures a maximum sealing effect between the sealing bush and the vehicle wall.

### BRIEF DESCRIPTION OF THE DRAWINGS

The detailed description will hereinafter be made in conjunction with the following drawing figures, wherein like numerals denote like elements, and:

FIG. 1 is a perspective illustration of a part of a vehicle wall with sealing bush and wiper drive shaft; and

FIG. 2 is an axial section through a sealing bush.

### DETAILED DESCRIPTION

The following detailed description is merely exemplary in nature and is not intended to limit application and uses. Furthermore, there is no intention to be bound by any theory presented in the preceding background or summary or the following detailed description.

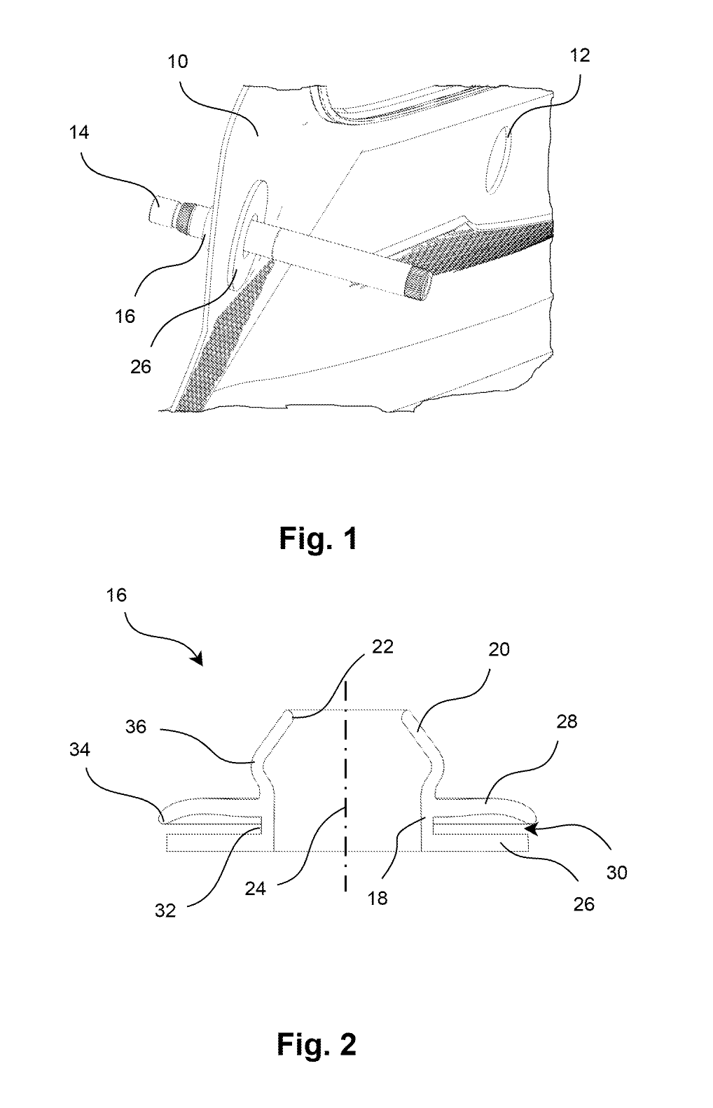

FIG. 1 shows a perspective illustration of a part of a vehicle wall 10, preferably it is a body part (so-called cowl) in the front region of a motor vehicle beneath the windshield. This vehicle wall 10 comprises two openings 12, through which respectively a wiper drive shaft 14 projects with associated sealing bush 16. In FIG. 1, for reasons of clarity, a wiper drive shaft 14 with associated sealing bush 16 is illustrated only at the opening which is situated in the foreground, where the rear opening 12 is shown without shaft 14 and sealing brush 16. The openings 12 are usually circular, but can also have different shapes.

In FIG. 2 the sealing bush 16 is illustrated in axial section. This includes substantially of a wall sealing section 18 for sealing with respect to the vehicle wall 10 and a shaft sealing section 20 adjoining towards the outer side of the vehicle. The wall sealing section 18 has an internal diameter that is greater than the diameter of the wiper drive shaft 14, which can be seen in FIG. 2 at a sealing region 22 of the shaft sealing section 20 with respect to the wiper drive shaft 14, which is not illustrated, so that the wall sealing section 18 does not lie against the wiper drive shaft 14. Two circumferential inner and outer sealing lips 26, 28, extending radially with respect to a center axis 24 of the sealing bush 16, are formed externally on the wall sealing section 18. Between the two sealing lips 26, 28 an annular gap 30 is formed, in which the edge region of the opening 12, illustrated in FIG. 1, is received in a sealing manner. In order to enable a radial displaceability, with respect to the center axis 24, of the wiper drive shaft 14 with respect to the vehicle wall 10, the external diameter 32 of the wall sealing section 18 is smaller by approximately 4 to approximately 10 mm than the diameter of the opening 12. In other words, an annular space with this height of approximately 4 to approximately 10 mm remains between the base of the annular gap 30 and the edge of the opening 12.

The outer sealing lip 28 has in the region of its outer edge preferably a seal region 34 that is curved towards the opposite sealing lip 26, in order to define with respect to the vehicle wall 10 a defined sealing region of sufficient pressing force and hence tightness. The sealing lip 28 presses only with this annular seal region 34 against the vehicle wall 10.

The shaft sealing section 20 widens in radial direction, starting from the wall sealing section 18, initially in a bell-like manner to form an annular bead 36. This annular bead 36 forms a barrier which respect to the water running along the vehicle wall 10, which barrier prevents a flow of the water towards the seal region 22. Behind the annular bead 36, the shaft sealing section 20 tapers substantially conically up to the seal region 22, which surrounds the wiper drive shaft 14 in a sealing manner.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A sealing bush of elastic material for a windshield wiping device of a vehicle for sealing a wiper drive shaft that is guided through an opening in a vehicle wall, comprising:
a cylindrical wall sealing section on which two circumferential sealing lips, extending radially with respect to a center axis, are formed for surrounding the vehicle wall on both sides; and
a thin-walled shaft sealing section that adjoins the cylindrical wall sealing section and tapes conically towards the center axis and continues into an annular seal region for sealing with respect to the wiper drive shaft.

2. The sealing bush according to claim 1, wherein the shaft sealing section, starting from the thin-wall sealing section enlarges in a bell-like manner in a radial direction to form an annular bead and subsequently tapers conically.

3. The sealing bush according to claim 1, wherein an external diameter of the cylindrical wall sealing section is between approximately 4 and approximately 10 mm smaller than a diameter of the opening.

4. The sealing bush according to claim 1, wherein the latter comprises EPDM.

5. The sealing bush according to claim 1, wherein the two circumferential sealing lips are situated on the outer side of the vehicle and has on the outer edge a seal region that is curved towards the opposite sealing lip.

6. A windshield wiping device for a vehicle, comprising:
a drive device;
a wiper drive shaft driven via the drive device;
a wiper arm mounted on the wiper drive shaft; and a sealing bush of elastic material for sealing the wiper drive shaft that is guided through an opening in a wall of the vehicle, comprising:
a cylindrical wall sealing section on which two circumferential sealing lips, extending radially with respect to a center axis, are formed for surrounding the wall on both sides; and
a thin-walled shaft sealing section that adjoins the cylindrical wall sealing section and tapes conically towards the center axis and continues into an annular seal region for sealing with respect to the wiper drive shaft.

7. (canceled)

8. The windshield wiping device according to claim 6, wherein the shaft sealing section, starting from the thin-walled sealing section enlarges in a bell-like manner in a radial direction to form an annular bead and subsequently tapers conically.

9. The windshield wiping device according to claim 6, wherein an external diameter of the cylindrical wall sealing section is between approximately 4 and approximately 10 mm smaller than a diameter of the opening.

10. The windshield wiping device according to claim 6, wherein the latter comprises EPDM.

11. The windshield wiping device according to claim 6, wherein the two circumferential sealing lips are situated on the outer side of the vehicle and has on the outer edge a seal region that is curved towards the opposite sealing lip.
